(19) United States
(12) Patent Application Publication
(10) Pub. No.: US 2026/0005267 A1
(43) Pub. Date: Jan. 1, 2026

(54) FUEL CELL BIPOLAR PLATE FLOW FIELD CONFIGURATIONS FOR IMPROVING MASS TRANSPORT

(71) Applicant: CUMMINS INC., Columbus, IN (US)

(72) Inventors: Qing NI, Mississauga (CA); Rainey Yu WANG, Richmond Hill (CA); Christian MILOJEVIC, St. Catharines (CA); Raul MONTANEZ GIMENEZ, Toronto (CA)

(21) Appl. No.: 19/253,249

(22) Filed: Jun. 27, 2025

Related U.S. Application Data
(60) Provisional application No. 63/665,920, filed on Jun. 28, 2024.

(51) Int. Cl. H01M 8/0265; H01M 8/10

(52) U.S. Cl. CPC H01M 8/0265; H01M 2008/1095

(57) ABSTRACT

The present disclosure generally relates to fuel cell systems and methods comprising one or more bipolar plates. The bipolar plates are configured to comprise different flow field channel arrangements. Each channel in the flow field channel arrangements is configured to comprise a micro-channel and a primary channel.

### CROSS-REFERENCE TO RELATED APPLICATIONS

This nonprovisional application claims the benefit and priority, under 35 U.S.C. § 119(e) and any other applicable laws or statues, to U.S. Provisional Patent Application Ser. No. 63/665,920 filed on Jun. 28, 2024, the entire disclosure of which is hereby expressly incorporated herein by reference.

### TECHNICAL FIELD

The present disclosure generally relates to fuel cell systems and methods for configuring and implementing bipolar plates with different flow field channel arrangements.

### BACKGROUND

A fuel cell produces electrical energy from chemical energy with high efficiency and low emissions. A cathode reduces oxygen on one side and supplies ions to a hermetic electrolyte. The electrolyte conducts the oxygen ions at a high temperature to an anode, where the ions oxidize hydrogen to form water. A resistive load connecting the anode and the cathode conducts electrons to perform work.

Fuel cells (e.g., solid oxide fuel cells (SOFC)) utilizing ceramic sintering technology are limited by a maximum manufacturable cell size and sinter-based manufacturing facilities that require large capital investment. However, metal interconnect-supported fuel cells utilizing thermal spray deposition offer a variety of manufacturing benefits including a more rugged design.

The metal interconnect-supported fuel cells typically include a bipolar plate (BPP) integrating both the anode and the cathode surfaces. The anode metallic surface is required to be relatively smooth to prevent gross defects from forming when the anode and electrolyte coatings are deposited. In addition, the metal interconnect needs to have one or more fuel flow fields designed to allow sufficient reducing gas, typically H₂ and/or CO, to reach the anode and electrolyte interface. The bipolar plates (BPP) typically comprise a porous membrane (e.g., a porous metallic membrane) bonded to the flow fields.

The flow fields connect the inlet and outlet ports of the bipolar plate (BPP) and are typically composed of a parallel channel-rib arrangements so that the gas or fluid flowing through the flow fields can be evenly distributed through the active area of the fuel cell. Design of the flow fields in the bipolar plate is critical for the performance of the fuel cell. Thus, the present disclosure is directed to systems and methods for designing one or more flow fields in the bipolar plate that allow reactant gas (e.g., air or hydrogen) to be efficiently distributed in order to enhance the performance of the fuel cell.

### SUMMARY

Embodiments of the present disclosure are included to meet these and other needs.

A first aspect of the present disclosure described herein is directed to a bipolar plate comprising a constricted flow channel arrangement comprising one or more constricted flow channels attached to an inlet at a first end and an outlet at a second end. The constricted flow channel may comprise a micro-channel and a primary channel.

In some embodiments of the first aspect, the constricted flow channel arrangement may comprise more than one constricted flow channel in an alternating arrangement.

In some embodiments of the first aspect, the micro-channel may comprise a cross-sectional area greater than zero and smaller than the cross-sectional area of the primary channel. In some embodiments of the first aspect, a ratio of the cross-sectional area of the micro-channel to the cross-sectional area of the primary channel may be about zero to about 1. In some embodiments of the first aspect, the cross-sectional area of the micro-channel may be determined by the width and/or height of the micro-channel. In some embodiments of the first aspect, a length of the micro-channel may be less than a length of the primary channel.

A second aspect of the present disclosure described herein is directed to a modular bipolar plate comprising more than one channel arrangement modules arranged between an inlet and an outlet, wherein gas or fluid is configured to flow through the channel arrangement from the inlet to the outlet.

In some embodiments of the second aspect, the modular bipolar plate may comprise at least includes two modules. In some embodiments of the second aspect, each of the modules may comprise more than one constricted flow channels. In some embodiments of the second aspect, each module may be connected to the inlet and the outlet via a feed channel. In some embodiments of the second aspect, the constricted flow channel may comprise a micro-channel and a primary channel.

In some embodiments of the second aspect, the constricted flow channels in each module may be arranged in an alternating arrangement. In some embodiments of the second aspect, each of the modules may be oriented at an angle relative to the feed channels.

A third aspect of the present disclosure described herein is directed to a bipolar plate comprising a varying width arrangement comprising channels with periodically variable channel size, wherein each channel comprises a wide region and a narrow region.

In some embodiments of the third aspect, the wide region of each channel may comprise a first rib configured to split the wide region into two distinct channels according to a split ratio. In some embodiments of the third aspect, the split ratio may be 1:2.

In some embodiments of the third aspect, the wide region may further comprise a second rib. The first rib and the second rib may be configured to split the wide channel into three channels. In some embodiments of the third aspect, the split ratio may be 1:3. In some embodiments of the third aspect, the first rib may comprise one or more islands.

In some embodiments of the third aspect, the wide region is split into a first channel, a second channel, and a third channel, and wherein the first channel is positioned to be offset from the third channel.

### BRIEF DESCRIPTION OF THE DRAWINGS

These and other features, aspects, and advantages of the present invention will become better understood when the following detailed description is read with reference to the accompanying drawings, in which like characters represent like parts throughout the drawings, wherein:

FIG. 1A is a schematic view of an exemplary fuel cell system including an air delivery system, a hydrogen delivery system, and a fuel cell module including a stack of multiple fuel cells;

FIG. 1B is a cutaway view of an exemplary fuel cell system including an air delivery system, hydrogen delivery systems, and a plurality of fuel cell modules each including multiple fuel cell stacks;

FIG. 1C is a perspective view of an exemplary repeating unit of a fuel cell stack of the fuel cell system of FIG. 1A;

FIG. 1D is a cross-sectional view of an exemplary repeating unit of the fuel cell stack of FIG. 1C;

FIG. 2A illustrates a channel arrangement in a flow-through channel arrangement in a bipolar plate (BPP);

FIG. 2B illustrates a channel arrangement and inter-digitated channel arrangement in a bipolar plate (BPP);

FIG. 2C illustrates the gas pressure in the flow-through channel arrangement shown in FIG. 2A;

FIG. 2D illustrates the gas pressure in the inter-digitated channel arrangement shown in FIG. 2B;

FIG. 3 illustrates a constricted flow channel arrangement;

FIG. 4 illustrates the static pressure profile along constricted flow channels in the constricted flow channel arrangement shown in FIG. 3;

FIG. 5 illustrates a pressure difference profile along constricted flow channels in the constricted flow channel arrangement shown in FIG. 3;

FIG. 6 illustrates a modular channel arrangement in a bipolar plate (BPP);

FIG. 7 illustrates the static pressure profile along neighboring channels in the modular channel arrangement shown in FIG. 6;

FIG. 8 illustrates a parallel modular channel arrangement in a bipolar plate (BPP);

FIG. 9 illustrates an angular modular channel arrangement in a bipolar plate (BPP);

FIG. 10 illustrates a two dimensional channel arrangement in a bipolar plate (BPP);

FIG. 11 illustrates a varying width arrangement in a bipolar plate (BPP);

FIG. 12 illustrates the differential pressure that can create a crossflow between the neighboring channels of a varying width arrangement in a bipolar plate (BPP);

FIG. 13 illustrates the static pressure profile along neighboring channels in the varying width arrangement shown in FIG. 11;

FIG. 14 illustrates a split channel arrangement in a bipolar plate (BPP);

FIG. 15 illustrates a split channel arrangement in a bipolar plate (BPP) where the wide region is split into distinct channels by the presence of two ribs;

FIG. 16 illustrates an offset split arrangement in a bipolar plate (BPP); and

FIG. 17 illustrates a split channel arrangement in a bipolar plate (BPP) where the wide region is split into distinct channels by the presence of a rib comprising islands.

### DETAILED DESCRIPTION

The present disclosure relates to systems and methods directed to a configuration of one or more flow fields in the bipolar plate that allows a reactant gas or fluid (e.g., air or hydrogen) to be efficiently distributed in order to enhance the performance of the fuel cell.

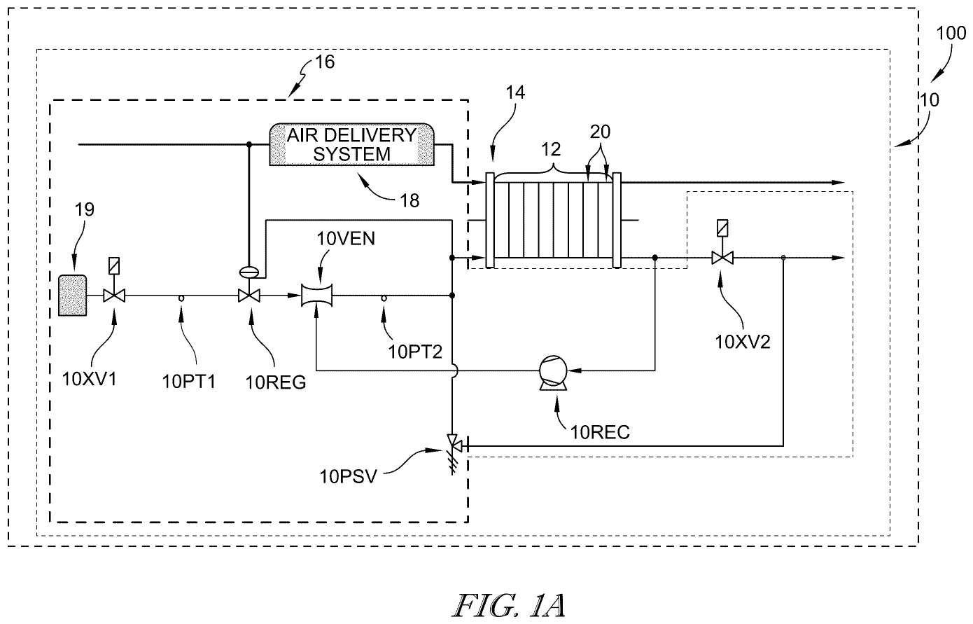

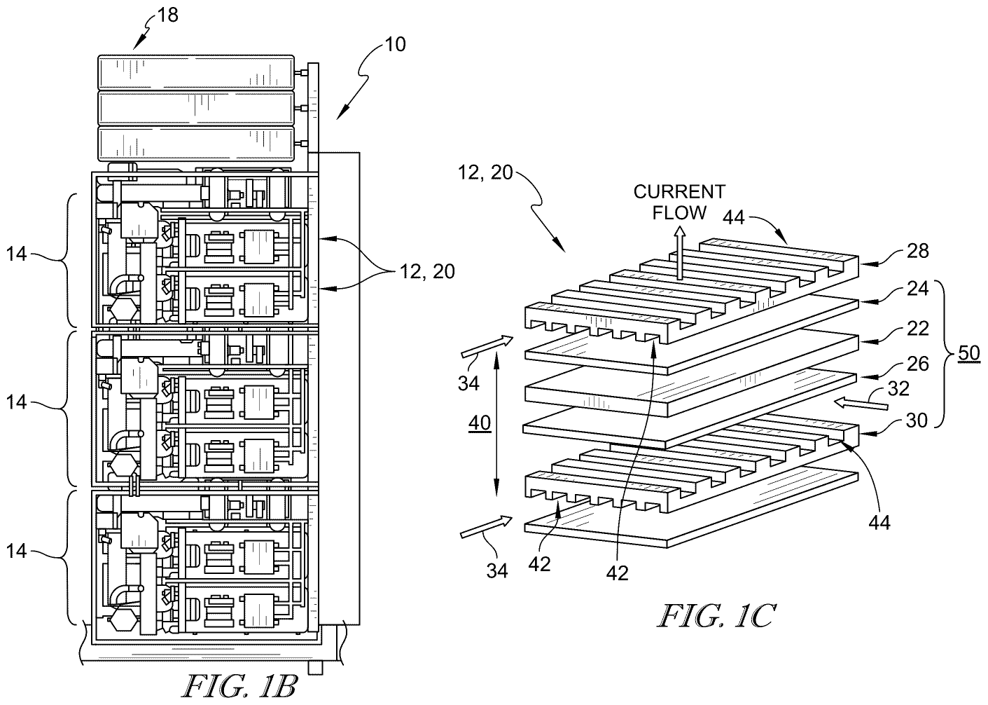

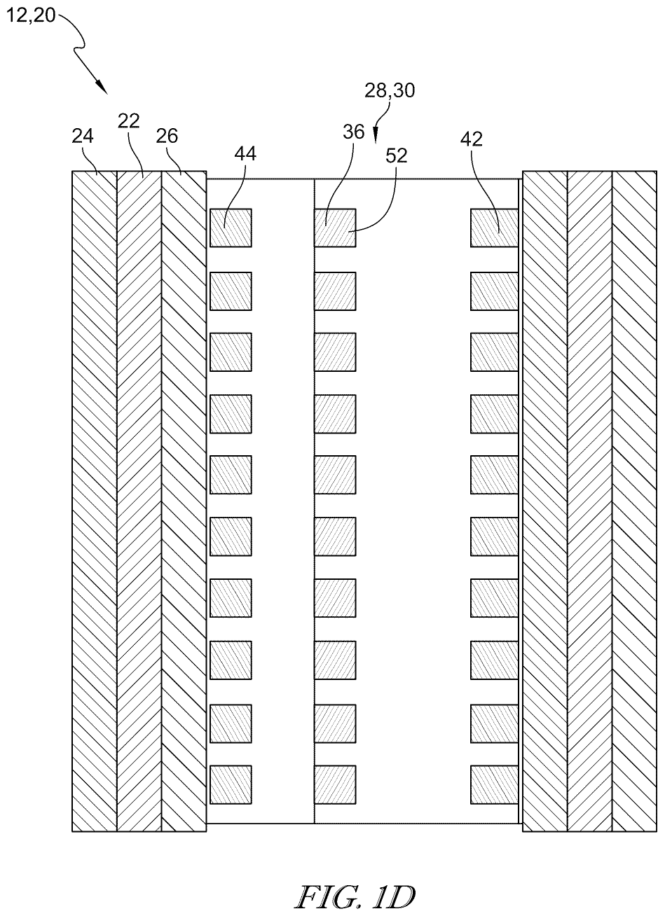

As shown in FIG. 1A, fuel cell systems 10 often include one or more fuel cell stacks 12 or fuel cell modules 14 connected to a balance of plant (BOP) 16, including various components, to support the electrochemical conversion, generation, and/or distribution of electrical power to help meet modern day industrial and commercial needs in an environmentally friendly way. As shown in FIGS. 1B and 1C, fuel cell systems 10 may include fuel cell stacks 12 comprising a plurality of individual fuel cells 20. Each fuel cell stack 12 may house a plurality of fuel cells 20 assembled together in series and/or in parallel. The fuel cell system 10 may include one or more fuel cell modules 14 as shown in FIGS. 1A and 1B.

Each fuel cell module 14 may include a plurality of fuel cell stacks 12 and/or a plurality of fuel cells 20. The fuel cell module 14 may also include a suitable combination of associated structural elements, mechanical systems, hardware, firmware, and/or software that is employed to support the function and operation of the fuel cell module 14. Such items include, without limitation, piping, sensors, regulators, current collectors, seals, and insulators.

The fuel cells 20 in the fuel cell stacks 12 may be stacked together to multiply and increase the voltage output of a single fuel cell stack 12. The number of fuel cell stacks 12 in a fuel cell system 10 can vary depending on the amount of power required to operate the fuel cell system 10 and meet the power need of any load. The number of fuel cells 20 in a fuel cell stack 12 can vary depending on the amount of power required to operate the fuel cell system 10 including the fuel cell stacks 12.

The number of fuel cells 20 in each fuel cell stack 12 or fuel cell system 10 can be any number. For example, the number of fuel cells 20 in each fuel cell stack 12 may range from about 100 fuel cells to about 1000 fuel cells, including any specific number or range of number of fuel cells 20 comprised therein (e.g., about 200 to about 800). In an embodiment, the fuel cell system 10 may include about 20 to about 1000 fuel cells stacks 12, including any specific number or range of number of fuel cell stacks 12 comprised therein (e.g., about 200 to about 800). The fuel cells 20 in the fuel cell stacks 12 within the fuel cell module 14 may be oriented in any direction to optimize the operational efficiency and functionality of the fuel cell system 10.

The fuel cells 20 in the fuel cell stacks 12 may be any type of fuel cell 20. The fuel cell 20 may be a polymer electrolyte membrane or proton exchange membrane (PEM) fuel cell, an anion exchange membrane fuel cell (AEMFC), an alkaline fuel cell (AFC), a molten carbonate fuel cell (MCFC), a direct methanol fuel cell (DMFC), a regenerative fuel cell (RFC), a phosphoric acid fuel cell (PAFC), or a solid oxide fuel cell (SOFC). In an exemplary embodiment, the fuel cells 20 may be a polymer electrolyte membrane or proton exchange membrane (PEM) fuel cell or a solid oxide fuel cell (SOFC).

In an embodiment shown in FIG. 1C, the fuel cell stack 12 includes a plurality of proton exchange membrane (PEM) fuel cells 20. Each fuel cell 20 includes a single membrane electrode assembly (MEA) 22 and a gas diffusion layer (GDL) 24, 26 on either or both sides of the membrane electrode assembly (MEA) 22 (see FIG. 1C). The fuel cell 20 further includes a bipolar plate (BPP) 28, 30 on the external side of each gas diffusion layer (GDL) 24, 26, as shown in FIG. 1C. The above-mentioned components, in particular the bipolar plate 30, the gas diffusion layer (GDL) 26, the membrane electrode assembly (MEA) 22, and the gas diffusion layer (GDL) 24 comprise a single repeating unit 50.

The bipolar plates (BPP) 28, 30 are responsible for the transport of reactants, such as fuel 32 (e.g., hydrogen) or oxidant 34 (e.g., oxygen, air), and cooling fluid 36 (e.g., coolant and/or water) in a fuel cell 20. The bipolar plates (BPP) 28, 30 can uniformly distribute reactants 32, 34 to an active area 40 of each fuel cell 20 through oxidant flow fields 42 and/or fuel flow fields 44 formed on outer surfaces of the bipolar plates (BPP) 28, 30. The active area 40, where the electrochemical reactions occur to generate electrical power produced by the fuel cell 20, is centered, when viewing the stack 12 from a top-down perspective, within the membrane electrode assembly (MEA) 22, the gas diffusion layer (GDL) 24, 26, and the bipolar plate (BPP) 28, 30.

The bipolar plates (BPP) 28, 30 may each be formed to have reactant flow fields 42, 44 formed on opposing outer surfaces of the bipolar plate (BPP) 28, 30, and formed to have coolant flow fields 52 located within the bipolar plate (BPP) 28, 30, as shown in FIG. 1D. For example, the bipolar plate (BPP) 28, 30 can include fuel flow fields 44 for transfer of fuel 32 on one side of the plate 28, 30 for interaction with the gas diffusion layer (GDL) 26, and oxidant flow fields 42 for transfer of oxidant 34 on the second, opposite side of the plate 28, 30 for interaction with the gas diffusion layer (GDL) 24. As shown in FIG. 1D, the bipolar plates (BPP) 28, 30 can further include coolant flow fields 52 formed within the plate (BPP) 28, 30, generally centrally between the opposing outer surfaces of the plate (BPP) 28, 30. The coolant flow fields 52 facilitate the flow of cooling fluid 36 through the bipolar plate (BPP) 28, 30 in order to regulate the temperature of the plate (BPP) 28, 30 materials and the reactants. The bipolar plates (BPP) 28, 30 are compressed against adjacent gas diffusion layers (GDL) 24, 26 to isolate and/or seal one or more reactants 32, 34 within their respective pathways 44, 42 to maintain electrical conductivity, which is required for robust operation of the fuel cell 20 (see FIGS. 1C and 1D).

The fuel cell system 10 described herein, may be used in stationary and/or immovable power system, such as industrial applications and power generation plants. The fuel cell system 10 may also be implemented in conjunction with an air delivery system 18. Additionally, the fuel cell system 10 may also be implemented in conjunction with a hydrogen delivery system and/or a source of hydrogen 19 such as a pressurized tank, including a gaseous pressurized tank, cryogenic liquid storage tank, chemical storage, physical storage, stationary storage, an electrolysis system, or an electrolyzer. In one embodiment, the fuel cell system 10 is connected and/or attached in series or parallel to a hydrogen delivery system and/or a source of hydrogen 19, such as one or more hydrogen delivery systems and/or sources of hydrogen 19 in the BOP 16 (see FIG. 1A). In another embodiment, the fuel cell system 10 is not connected and/or attached in series or parallel to a hydrogen delivery system and/or a source of hydrogen 19.

The present fuel cell system 10 may also be comprised in mobile applications. In an exemplary embodiment, the fuel cell system 10 is in a vehicle and/or a powertrain 100. A vehicle 100 comprising the present fuel cell system 10 may be an automobile, a pass car, a bus, a truck, a train, a locomotive, an aircraft, a light duty vehicle, a medium duty vehicle, or a heavy-duty vehicle. Type of vehicles 100 can also include, but are not limited to commercial vehicles and engines, trains, trolleys, trams, planes, buses, ships, boats, and other known vehicles, as well as other machinery and/or manufacturing devices, equipment, installations, among others.

The vehicle and/or a powertrain 100 may be used on roadways, highways, railways, airways, and/or waterways. The vehicle 100 may be used in applications including but not limited to off highway transit, bobtails, and/or mining equipment. For example, an exemplary embodiment of mining equipment vehicle 100 is a mining truck or a mine haul truck.

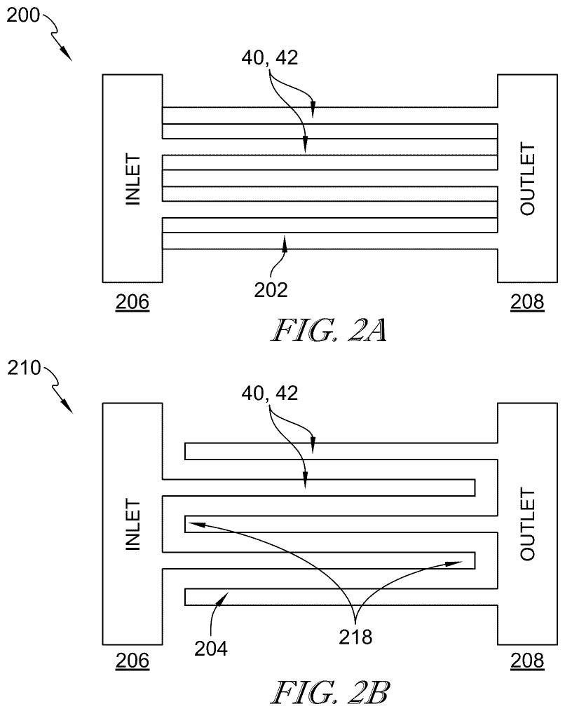

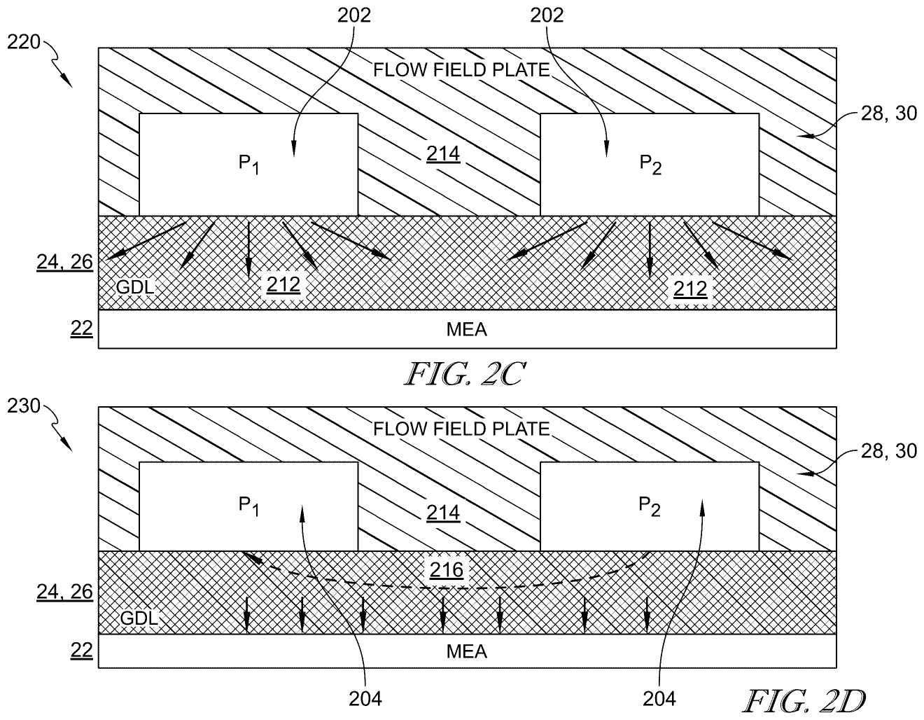

Typically, as shown in FIGS. 2A and 2B, any channel arrangement of the one or more flow fields 42, 44 may include a flow-through channel arrangement 200 and/or an inter-digitated channel arrangement 210. The fluid flow goes through a series of parallel flow fields 42, 44 that may be flow-through channels 202 and/or inter-digitated channels 204, thereby distributing the fuel and/or oxidant through the entire area. Each flow-through channel 202 in the flow-through channel arrangement 200 is connected to an inlet 206 and an outlet 208. Each inter-digitated channel 204 in the inter-digitated channel arrangement 210 is closed at one end 218. The inter-digitated channels 204 alternate with closing at the inlet 206 and closing at the outlet 208. As a result, the reactant gas flowing from the inlet 206 passes through the gas diffusion layer (GDL) 24, 26 (shown in FIG. 1C) to reach the neighboring inter-digitated channel 204 before exiting via the outlet 208.

In one embodiment, a gas or fluid (e.g., gas, liquid, air, hydrogen, or water) may flow in the flow-through channels 202 and/or the inter-digitated channels 204 in the flow-through channel arrangement 200 and/or the inter-digitated channel arrangement 210, respectively. FIGS. 2C and 2D illustrate the fluid pressure in a flow-through channel arrangement 220 and the fluid pressure in an inter-digitated channel arrangement 230.

In the flow-through channel arrangement 220 (FIG. 2C), the fluid pressures in neighboring flow-through channels 202 are the same (i.e., P1=P2). The fluid in the gas diffusion layer (GDL) 24, 26 is stagnant. When the pressures in neighboring flow-through channels 202 are the same, the transportation of air, oxygen, and/or hydrogen occurs via diffusion through the GDL 24, 26, as indicated by the arrows 212 of FIG. 2B. The area under the ribs 214, which comprise solid bipolar plates 28, 30 between the flow-through channels 202, is less accessible than the area directly under the flow-through channels 202. Therefore, the areas under the ribs 214 can lose efficiency at high current load due to the depletion of reactant species in these areas.

In the inter-digitated channel arrangement 230 (FIG. 2D), the neighboring inter-digitated channels 204 have a differential pressure (i.e., P1 does not equal to P2). Due to this differential pressure (e.g., inlet pressure may be greater than outlet pressure or vice versa), air, oxygen, and/or hydrogen may flow through the GDL 24, 26 from one inter-digitated channel 204 to another inter-digitated channel 204 via a crossflow mechanism. The crossflow 216 is illustrated by a dashed line in FIG. 2D.

Due to this crossflow 216, air, oxygen, and/or hydrogen are brought closer to the MEA 22. Therefore, diffusion in the inter-digitated channels 204 is more efficient than the diffusion in the flow-through channels 202. Nevertheless, although inter-digitated design channel arrangements 210 have better mass transport due to crossflow, there are two major drawbacks with this design.

First, the pressure drop across the inter-digitated channels 204 is higher than the pressure drop across the flow-through channels 202. A higher pressure drop incurs more power from an air compressor or a hydrogen recirculation pump of fuel cell engine, thereby decreasing the overall net power. Second, product water may accumulate at the closed end 218 (see FIG. 2B) of the inter-digitated channels 204. The accumulated water can potentially flood the inter-digitated channels 204 causing poor performance of the fuel cell 20.

The present disclosure is directed to systems and/or methods of implementing flow field channel arrangements and/or configurations in bipolar plates (BPP) 28, 30 that utilize a crossflow mechanism while avoiding pressure drop and water accumulation issues, as discussed above.

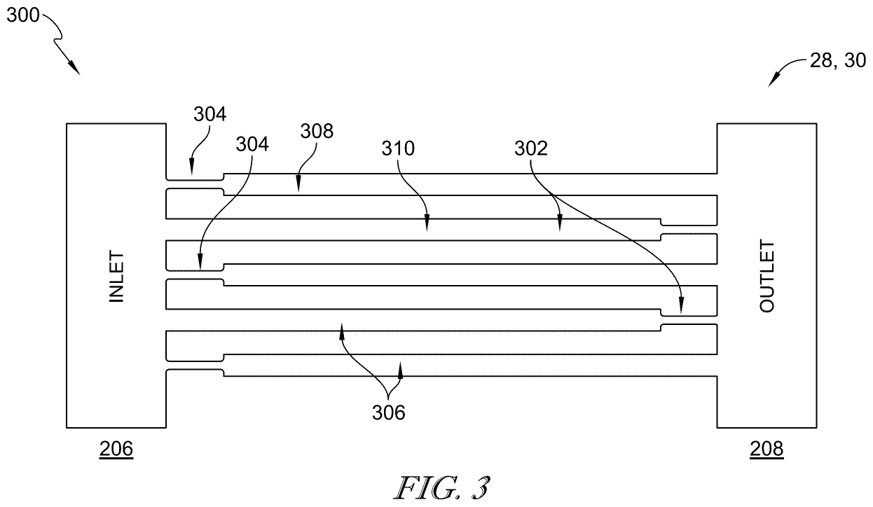

In one embodiment, as shown in FIG. 3, a constricted flow field channel arrangement 300 is configured to include one or more constricted flow channels 302. The constricted flow field channel arrangement 300 can include about 2 to about 20 constricted flow channels 302, including any number or range of constricted flow channels 302 comprised therein. Each constricted flow channels 302 comprises a micro-channel 304 and a primary channel 306. As illustrated, each constricted flow channel 302 has one micro-channel 304 located either at the inlet 206 or at the outlet 208. The constricted flow channels 302 comprising micro-channels 304 located at the inlet 206 are positioned to alternate with the constricted flow channels 302 comprising micro-channels 304 located at the outlet 208. In some embodiments, the constricted flow channels 302 may have more than one micro-channels 304 and/or more than one primary channels 306. In some embodiments, the constricted flow channels 302 comprising micro-channels 304 located at the inlet 206 may not be positioned to alternate with the constricted flow channels 302 comprising micro-channels 304 located at the outlet 208.

The micro-channels 304 may be configured with a cross-sectional area greater than zero (0) and smaller than the cross-sectional area of the primary channel 306. The cross-sectional area of the primary channel 306 may be based on other constraints or parameters of the fuel cell 20. The ratio of the cross-sectional area of the micro-channel 304 to the cross-sectional area of the primary channel 306 (e.g., M:P) may range from about zero (0) to about one (1), including any value or range comprised therein. The cross-sectional area of the micro-channel 304 may be determined by the width and/or the height of the micro-channel 304. In some embodiments, the length of the micro-channel 304 may be less than the length of the primary channel 306 in each constricted flow channel 302. In some embodiments, the length of the micro-channel 304 may be equal to or greater than the length of the primary channel 306 in each constricted flow channel 302.

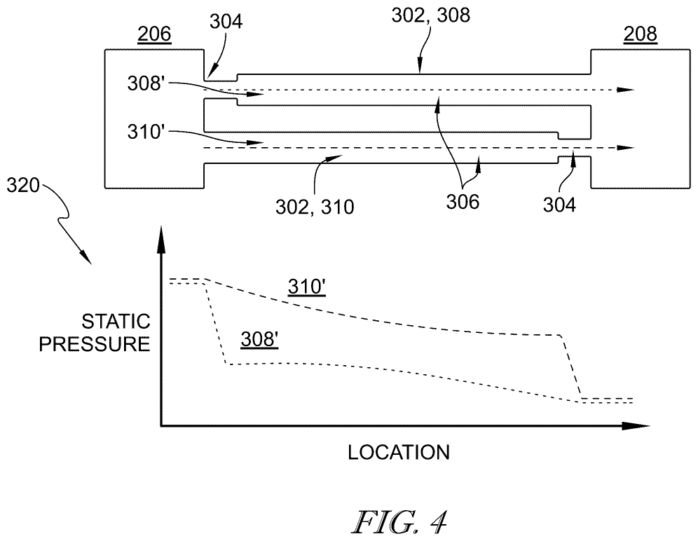

The cross-sectional area of the micro-channel 304 controls the pressure difference and the crossflow between consecutive constricted flow channels 302. The cross-sectional area of the micro-channel 304 controls the overall pressure drop from the inlet 206 to the outlet 208. FIG. 4 illustrates the static pressure profile 320 along two constricted flow channels 308, 310.

The constricted flow channel 308 includes the short micro-channel 304 at the inlet 206 followed by the primary channel 306. The constricted flow channel 310 includes the primary channel 306 followed by the short micro-channel 304 at the outlet 208. The static pressure 308′ along the constricted flow channel 308 is different from the static pressure 310′ along the constricted flow channel 310 and depends on the location of the micro-channel 304 and primary channel 306 in each of the constricted flow channels 308, 310. A sudden drop in the static pressure 308′ is observed at the beginning of the constricted flow channel 308 because of the micro-channel 304 positioned next to the inlet 206. Similarly, a sudden drop in the static pressure 310′ is observed towards the end of the constricted flow channels 310 because of the micro-channel 304 positioned next to the outlet 208.

Decreasing the cross-sectional area of the micro-channel 304, increases the pressure difference between the neighboring primary channels 306, thereby inducing more crossflow between the neighboring primary channels 306. Decreasing the cross-sectional area of the micro-channel 304 also increases the total pressure drop from the inlet 206 to the outlet 208. Increasing the cross-sectional area of the micro-channel 304 decreases the pressure difference between the neighboring primary channels 306, thereby inducing less crossflow between the neighboring primary channels 306. Increasing the cross-sectional area of the micro-channels 304 also decreases the total pressure drop from the inlet 206 to the outlet 208.

When the micro-channels 304 are completely closed, the constricted flow field channel arrangement 300 is equivalent to the inter-digitated channel arrangement 210. When the micro-channels 304 are completely open, the constricted flow field channel arrangement 300 is equivalent to the flow-through channel arrangement 220. Therefore, the constricted flow field channel arrangement 300 can be designed to have a higher mass transport efficiency due to crossflow, while avoiding the high-pressure loss from the inlet 206 to the outlet 208 as seen in the inter-digitated channel arrangement 210.

In addition, the micro-channels 304 have a higher fluid flow velocity than the primary channels 306. The high fluid flow velocity helps purge out condensed water, thereby mitigating the flooding problem observed in the inter-digitated channel arrangement 210.

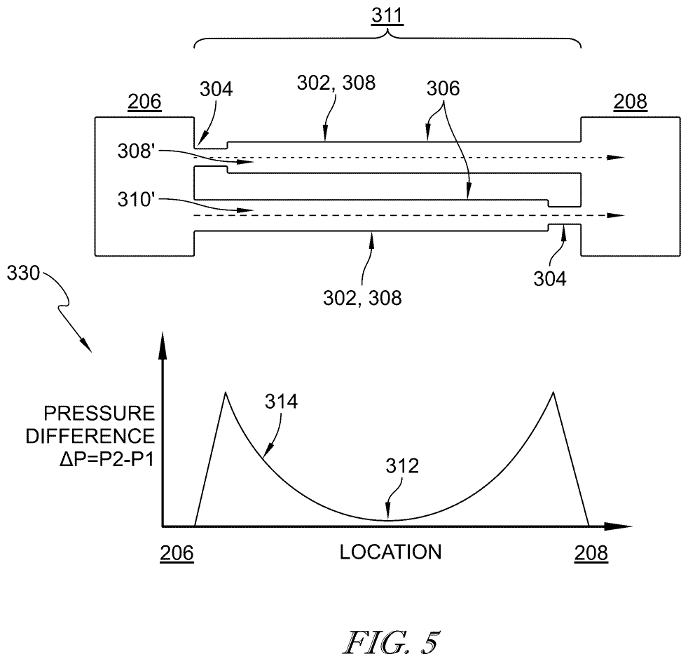

In the constricted flow field channel arrangement 300, the magnitude of crossflow between neighboring constricted flow channels 310, 308 depends on the pressure difference (ΔP) 314 between the pressure in the constricted flow channels 310 (P2) and the constricted flow channels 308 (P1) (see FIG. 5). This pressure difference is not uniform throughout the length of the constricted flow channels 310, 308. However, due to crossflow, the pressure difference between neighbouring channels may balance out and/or equilibrate between constrictions (e.g., micro-channel 304).

As illustrated in FIG. 5, a pressure difference profile 330 shows that this pressure difference 314 is highest next to the micro-channels 304, and lowest in the middle region 312. The longer the distance between the inlet 206 and the outlet 208, the lower is the pressure difference 314 between the two constricted flow channels 310, 308. Therefore, it may be desirable to limit an inlet-to-outlet distance 311 in the constricted flow field channel arrangement 300 to avoid regions where the pressure difference 314 drops to near zero in the middle region 312. For similar reasons, it may be desirable to limit the inlet-to-outlet distance 311 in the inter-digitated channel arrangements 210 to avoid regions where the pressure difference 314 drops to near zero in the middle region 312.

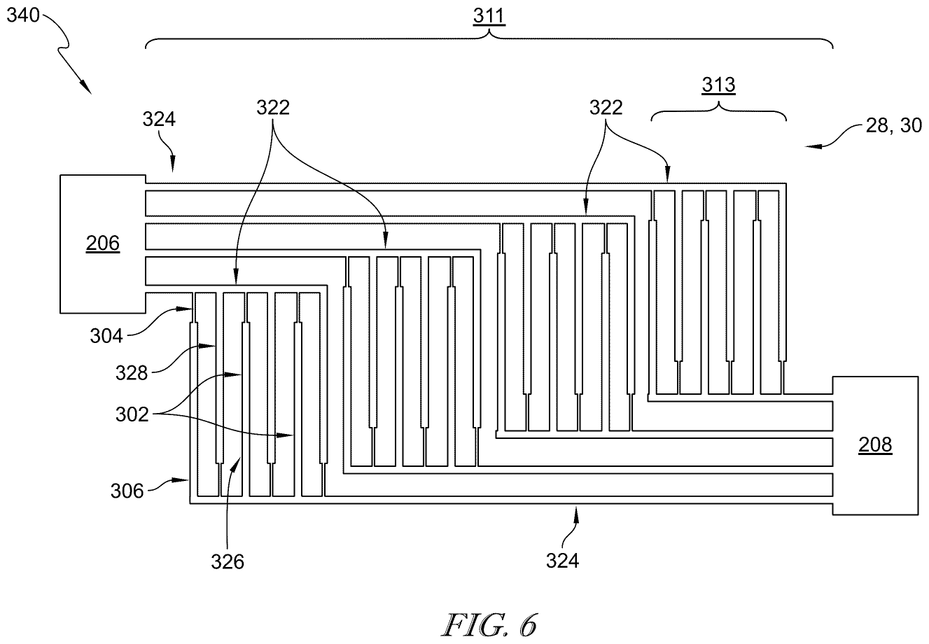

In some embodiments, the length of inlet-to-outlet distance 311 may not be conveniently shortened, due to constraints imposed by other factors, such as fuel cell stack 12 product size requirements. Such fuel cell stacks 12 may comprise a modular channel arrangement 340 in bipolar plates (BPP) 28, 30, as shown in FIG. 6. The modular channel arrangements 340 include one or more modules 322 with constricted flow channels 302.

Each module 322 may be connected between the inlet 206 and the outlet 208. Each module 322 may be parallel to each other. The modular channel arrangement 340 may include about 2 to about 20 modules 322, including any number or range of modules 322 comprised therein. In some embodiments, the modular channel arrangement 340 may include more than 20 modules 322. Each module 322 may include about 2 to about 20 constricted flow channels 302, including any number or range of constricted flow channels 302 comprised therein. In some embodiments, each module 322 may include more than 20 constricted flow channels 302.

In one embodiment, as shown in FIG. 6, the modular channel arrangement 340 includes four modules 322, each consisting of six constricted flow channels 302. In this embodiment, the constricted flow channels 302 in the modules 322 may be oriented vertically-parallel to the feed channels 324 to form a vertically-parallel modular channel arrangement 340 in the bipolar plates (BPP) 28, 30.

Each of the modules 322 is connected to the inlet 206 and the outlet 208 via feed channels 324. By including more than one module 322, a length 313 of the constricted flow channels 302 in each module 322 is kept shorter than the length of inlet-to-outlet distance 311 as illustrated in FIG. 6. Each module 322 includes constricted flow channels 302 with micro-channels 304 located closer to the inlet 206 and constricted flow channels 302 with micro-channels 304 located closer to the outlet 208 in an alternating arrangement. The length 313 of the constricted flow channels 302 and the length of inlet-to-outlet distance 311 may be constrained by the design of the fuel cell stack 12 comprising the bipolar plates (BPP) 28, 30.

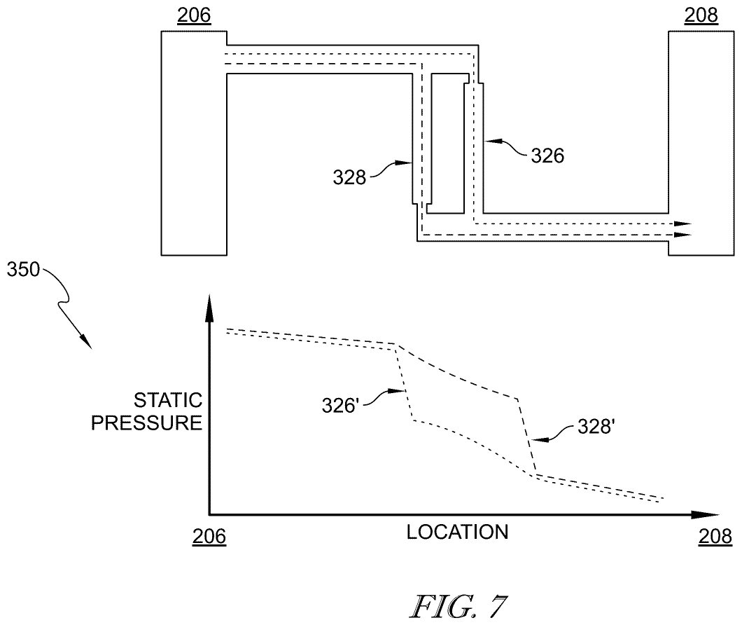

FIG. 7 illustrates a static pressure profile 350 of neighboring constricted flow channels 326, 328 in the modular channel arrangement 340. A static pressure profile 326′ along the constricted flow channel 326 with a micro-channel located closer to the inlet 206 and a static pressure profile 328′ along the constricted flow channel 328 with a micro-channel located closer to the outlet 208 is shown. The static pressure profiles 326′ and 328′ are representative of the pressure profiles in constricted flow channels 308, 310, previously illustrated in FIG. 5.

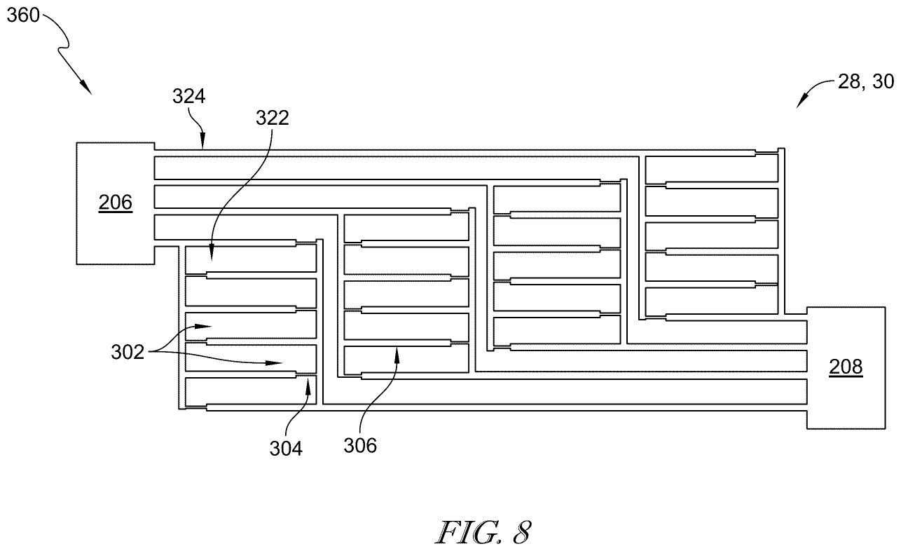

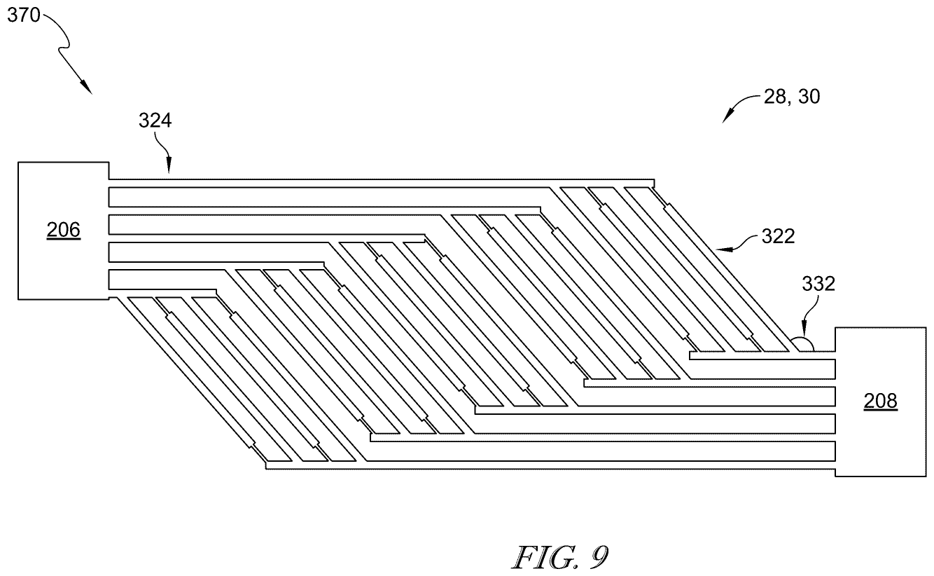

In some embodiments, the constricted flow channels 302 in the modules 322 may also be oriented horizontally-parallel to the feed channels 324 to form a horizontally-parallel modular channel arrangement 360 in the bipolar plates (BPP) 28, 30, as shown in the FIG. 8. In some embodiments, the constricted flow channels 302 in the modules 322 may be oriented at an angle 332 relative to the feed channels 324 to form an angular modular channel arrangement 370 in the bipolar plates (BPP) 28, 30, as shown in the FIG. 9.

A change in the angle of the constricted flow channels 302 relative to the feed channels 324 allows for the adjustment of the lengths of the constricted flow channels 302 and the lengths of the primary channels 306, as needed to support crossflow. The angle 332 may range from about 90 degrees to about 175 degrees, including any angle or range comprised therein. For example, the angle 332 may be about 90 degrees to about 120 degrees, about 120 degrees to about 140 degrees, or about 140 degrees to about 175 degrees.

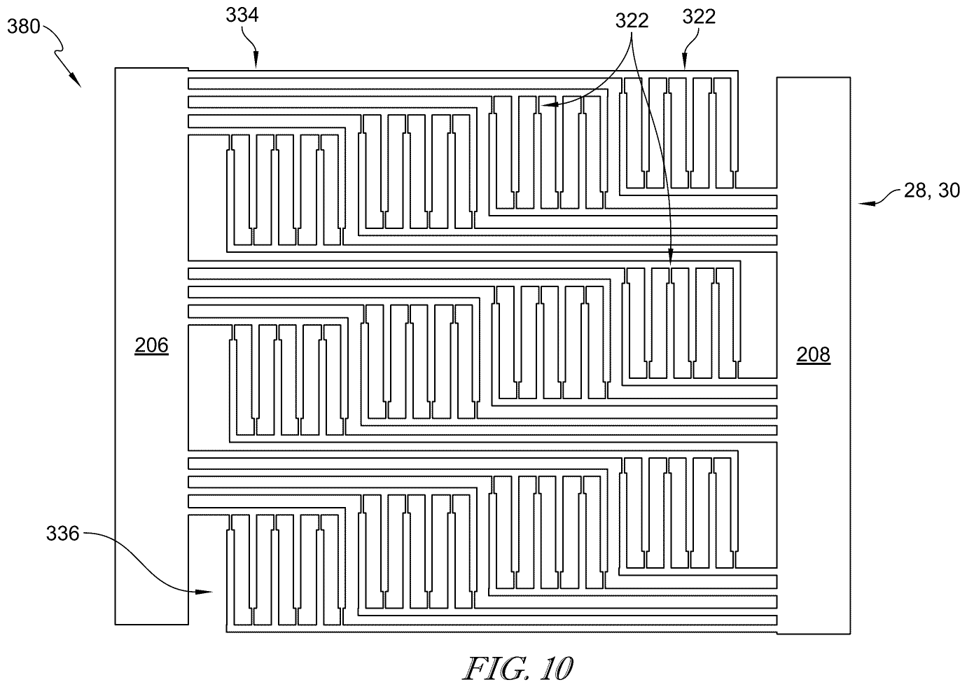

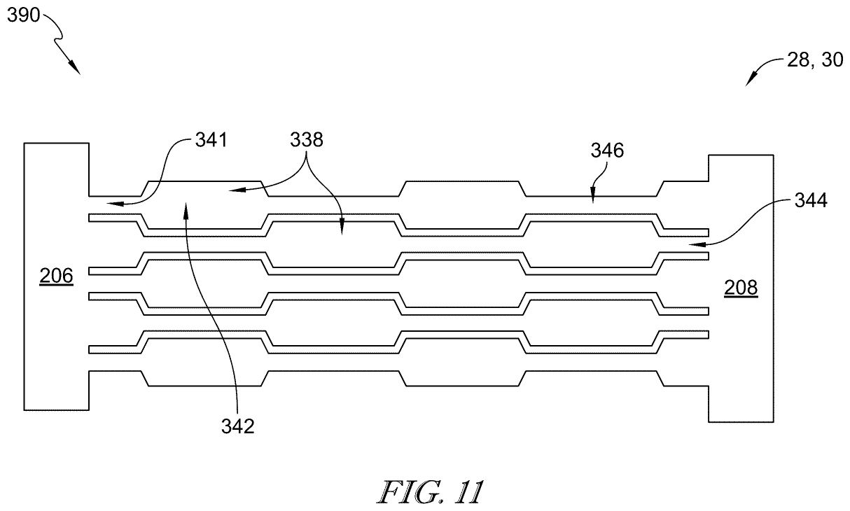

In some embodiments, modules 322 may be positioned in a two dimensional array to form a two dimensional channel arrangement 380 in the bipolar plates (BPP) 28, 30, as shown in FIG. 10. The two dimensional channel arrangement 380 may include about 2 to about 20 modules 322 in a first dimension 334, including any number or range of modules 322 comprised therein. The two dimensional channel arrangement 380 may include about 2 to about 20 modules 322 in a second dimension 336, including any number or range of modules 322 comprised therein.

The present disclosure is also directed to configurations and methods of implementing flow field channel arrangements that comprise varying channel widths. In one embodiment, as shown in FIG. 11, the bipolar plates (BPP) 28, 30 can include a varying width arrangement 390 comprising channels 338 with periodically variable channel size. The periodically variable channel sizes may include channels 338 that may comprise a narrow region 341 with a first width followed by a wide region 342 with a second width that is greater than the first width. Alternatively, the channels 338 may comprise the wide region 342 with the second width followed by the narrow region 341 with the first width that is less than the second width. The channels 338 may vary in width, length (as previously described), and/or depth. Neighboring channels 338 may comprise alternating or varying channel width and/or depth patterns as well.

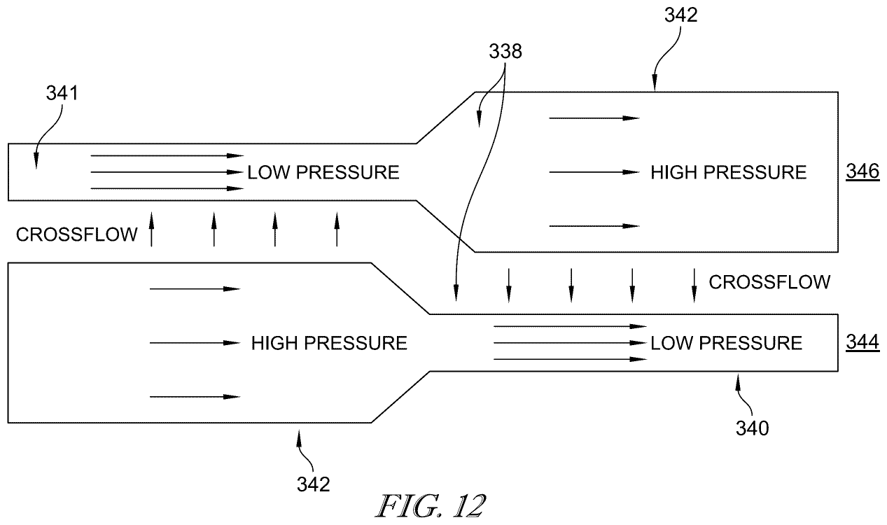

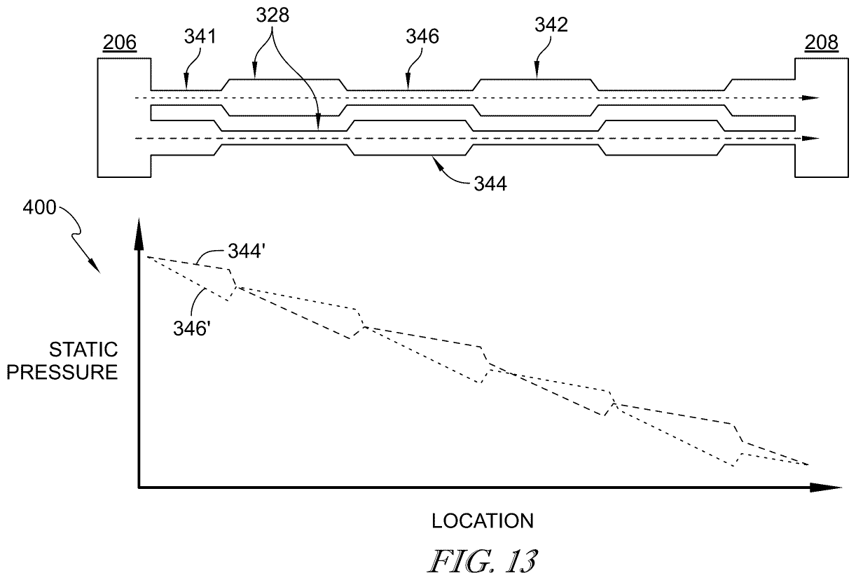

This varying width arrangement 390 implements sudden constrictions and expansions of the fluid flowing through the channels 338. When the fluid expands from the narrow region 341 to the wide region 342, the fluid velocity decreases, and the local pressure increases according to Bernoulli's principle. When the fluid contracts, the velocity suddenly increases, and the pressure decreases. Because the expansion and contraction patterns of each channel 338 is opposite from that of the neighboring channel, there is always a differential pressure. The differential pressure creates crossflow between the neighboring channels 344, 346, as illustrated in FIG. 12. A pressure profile 400, illustrating the static pressure 344′, 346′ along the length of the channels 344, 346, is show FIG. 13.

Referring to FIGS. 12 and 13, both channels 344, 346 have narrow regions 341 and wide region 342 in an alternating order. When a fluid stream travels through the narrow region 341, the fluid stream will have a more rapid drop in static pressure, and vice versa. When a fluid stream travels from a narrow region 341 to a wide region 342, the fluid stream suddenly gains pressure. When a fluid stream travels from a wide region 342 to a narrow region 341, the fluid stream suddenly loses static pressure. The alternating narrow and wide regions 341, 342 create static pressure difference along the neighboring channels 344, 346. In some embodiments, narrower channels may be favored for better electrical contact and mechanical support for the GDL 24, 26 and MEA 22. To maintain such narrow channels, variations may be incorporated into the channel configuration.

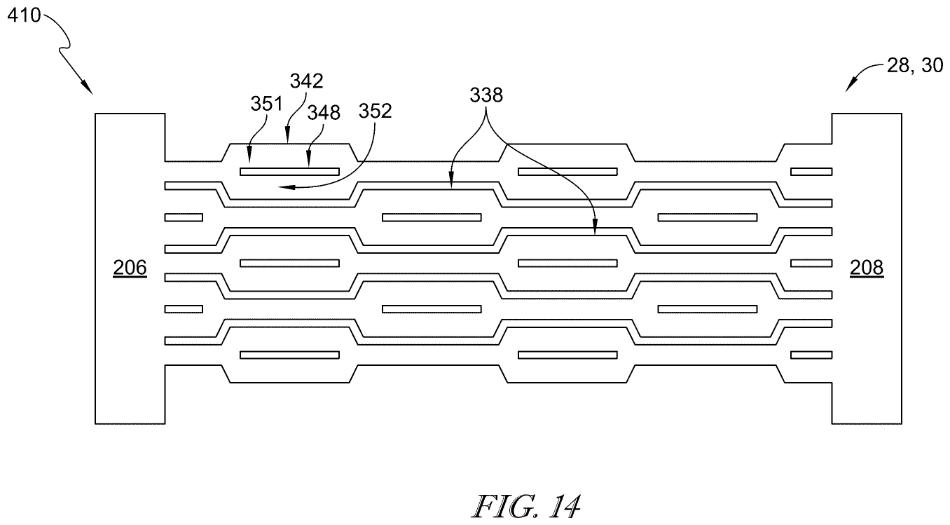

FIG. 14 illustrates a split channel arrangement 410 in the bipolar plates (BPP) 28, 30. In one embodiment, as shown in FIG. 14, the split channel arrangement 410 comprises the wide region 342 being split into distinct channels 351, 352 based on a split ratio. In some embodiments, the split ratio may split the wide region 342 in a 1:2 split ratio. The wide region 342 may include a rib 348, splitting the wide region 342 into two distinct channels 351, 352 which merge again at opposite sides of the rib 348. Fluid flow expansion and contraction still occurs along the length of the channels 338, and the width of the channels 338 are decreased to improve mechanical support of the GDL 24, 26 and MEA 22. The presence of the rib 348 may also help electrical conductance in the fuel cell 20.

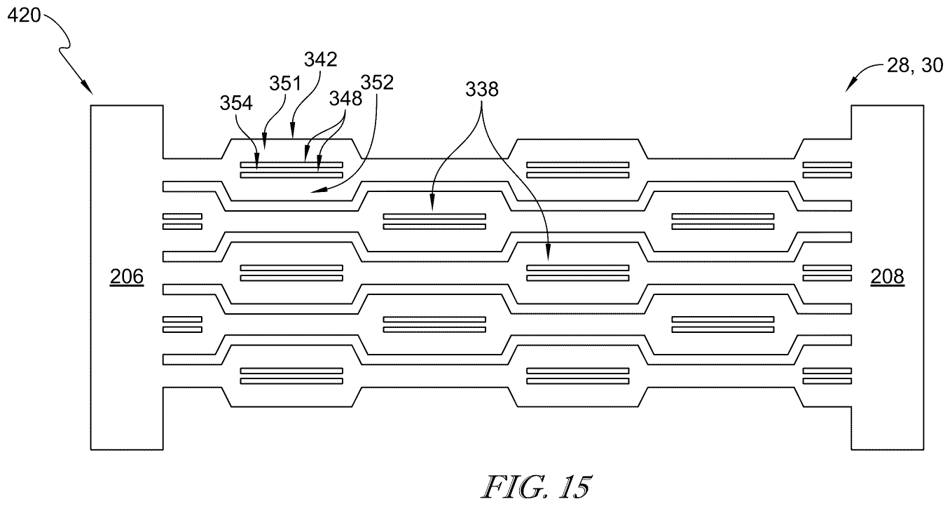

In some embodiments, the split ratio may split the wide region 342 in a 1:3 split ratio. FIG. 15 illustrates a split channel arrangement 420 with a 1:3 split ratio. The split channel arrangement 420 comprises the wide region 342 being split into distinct channels 351, 352, 354 based on the split ratio. The 1:3 split also allows flow through a middle channel 354 of the three-way split, so the pressure drop is lower compared to a two-way split shown in FIG. 14. In the 1:3 split shown in FIG. 15, the pressure in the channels 351, 352, 354 may be similar, resulting is almost no crossflow between these channels 351, 352, 354.

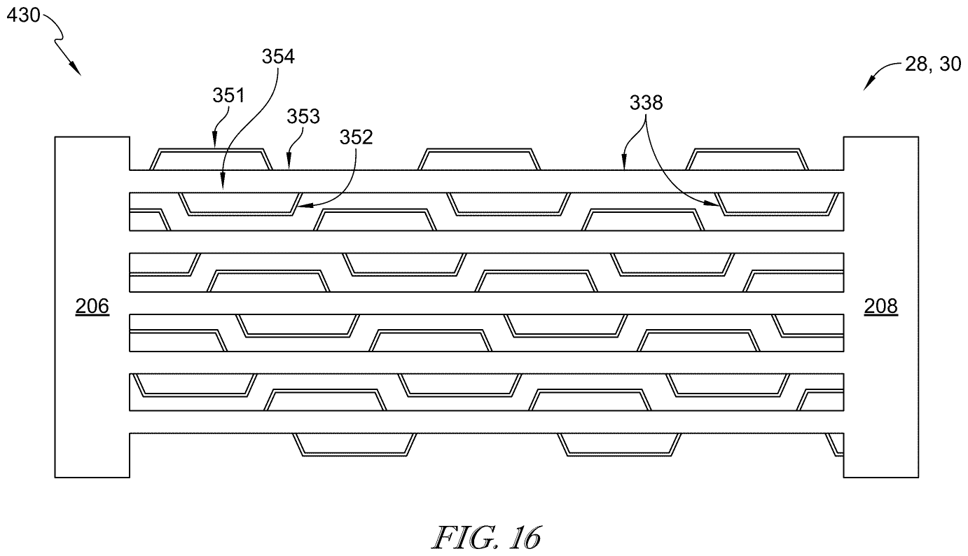

In some embodiments, an offset split arrangement 430, as shown in FIG. 16 may occur. This offset split arrangement may include an offset 353 between the channels 351 and 352, so that there is a further pressure difference between the channels 351, 352, 354. An offset split arrangement 430 refers to an arrangement where the channels 351 and 352 are not positioned symmetrical to each other around channel 354.

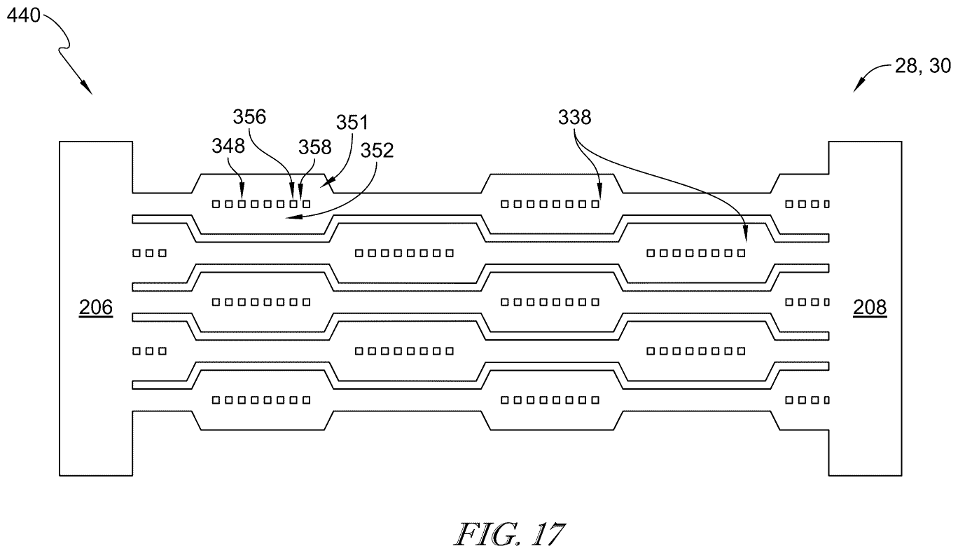

In some embodiments, an island split arrangement 440, as shown in FIG. 17, may comprise the rib 348. The rib 348 comprises one or more islands 356 that lower flow resistance and improve reactant mass transport. Each channel may comprise any number of islands 356. In some embodiments, the number of islands 356 on each rib 348 may range from about 1, at least 1, more than 1, or 1 or more. In other embodiments, there may be from about 2 to about 25, from about 4 to about 20, from about 6 to about 10 islands in each rib 348, including any number or range of islands comprised therein. The embodiment of FIG. 17 shows ribs 348 comprising about 8 islands 356 each.

One or more gaps 358 between the islands 356 may provide additional access routes to the GDL 24, 26 as compared to the 1:2 split shown in FIG. 14. The gaps 358 may be any length, width, and/or distance as necessary to provide additional flow access in and through the channels 351, 352. In some embodiments, the gaps 358 between the islands 356 have the same, less, or greater length, distance, and/or width than the islands 356.

The present disclosure is also directed to a method of operating a fuel cell stack 12 comprising the method comprising bipolar plates (BPP) 28, 30 with flow field arrangements configured to improve operation of the fuel cell stack 12. The method may comprise implementing bipolar plates (BPP) 28, 30 with the constricted flow field channel arrangement 300, the modular channel arrangements 340, the horizontally-parallel modular channel arrangement 360, a vertically-parallel modular channel arrangement, the angular modular channel arrangement 370, the two dimensional channel arrangement 380, the varying width arrangement 390, split channel arrangement 410, 420, the offset split arrangement 430, or the island split arrangement 440.

The method may comprise improving mass transport of a fluid through the constricted flow field channel arrangement 300, the modular channel arrangements 340, the horizontally-parallel modular channel arrangement 360, a vertically-parallel modular channel arrangement, the angular modular channel arrangement 370, the two dimensional channel arrangement 380, the varying width arrangement 390, split channel arrangement 410, 420, the offset split arrangement 430, or the island split arrangement 440.

As used herein, an element or step recited in the singular and proceeded with the word “a” or “an” should be understood as not excluding plural of said elements or steps, unless such exclusion is explicitly stated. Furthermore, references to “one embodiment” of the presently described subject matter are not intended to be interpreted as excluding the existence of additional embodiments that also incorporate the recited features, numerical ranges of units, measurements, and/or values comprise, consist essentially or, or consist of all the numerical values, units, measurements, and/or ranges including or within those ranges and/or endpoints, whether those numerical values, units, measurements, and/or ranges are explicitly specified in the present disclosure or not.

Unless defined otherwise, technical and scientific terms used herein have the same meaning as is commonly understood by one of ordinary skill in the art to which this disclosure belongs. The terms “first,” “second,” “third” and the like, as used herein do not denote any order or importance, but rather are used to distinguish one element from another. The term “or” is meant to be inclusive and mean either or all of the listed items. In addition, the terms “connected” and “coupled” are not restricted to physical or mechanical connections or couplings, and can include electrical connections or couplings, whether direct or indirect.

Moreover, unless explicitly stated to the contrary, embodiments “comprising,” “including,” or “having” an element or a plurality of elements having a particular property may include additional such elements not having that property. The term “comprising” or “comprises” refers to a composition, compound, formulation, or method that is inclusive and does not exclude additional elements, components, and/or method steps. The term “comprising” also refers to a composition, compound, formulation, or method embodiment of the present disclosure that is inclusive and does not exclude additional elements, components, or method steps.

The phrase “consisting of” or “consists of” refers to a compound, composition, formulation, or method that excludes the presence of any additional elements, components, or method steps. The term “consisting of” also refers to a compound, composition, formulation, or method of the present disclosure that excludes the presence of any additional elements, components, or method steps.

The phrase “consisting essentially of” or “consists essentially of” refers to a composition, compound, formulation, or method that is inclusive of additional elements, components, or method steps that do not materially affect the characteristic(s) of the composition, compound, formulation, or method. The phrase “consisting essentially of” also refers to a composition, compound, formulation, or method of the present disclosure that is inclusive of additional elements, components, or method steps that do not materially affect the characteristic(s) of the composition, compound, formulation, or method steps.

Approximating language, as used herein throughout the specification and claims, may be applied to modify any quantitative representation that could permissibly vary without resulting in a change in the basic function to which it is related. Accordingly, a value modified by a term or terms, such as “about,” and “substantially” is not to be limited to the precise value specified. In some instances, the approximating language may correspond to the precision of an instrument for measuring the value. Here and throughout the specification and claims, range limitations may be combined and/or interchanged. Such ranges are identified and include all the sub-ranges contained therein unless context or language indicates otherwise.

As used herein, the terms “may” and “may be” indicate a possibility of an occurrence within a set of circumstances; a possession of a specified property, characteristic or function; and/or qualify another verb by expressing one or more of an ability, capability, or possibility associated with the qualified verb. Accordingly, usage of “may” and “may be” indicates that a modified term is apparently appropriate, capable, or suitable for an indicated capacity, function, or usage, while taking into account that in some circumstances, the modified term may sometimes not be appropriate, capable, or suitable.

It is to be understood that the above description is intended to be illustrative, and not restrictive. For example, the above-described embodiments (and/or aspects thereof) may be used individually, together, or in combination with each other. In addition, many modifications may be made to adapt a particular situation or material to the teachings of the subject matter set forth herein without departing from its scope. While the dimensions and types of materials described herein are intended to define the parameters of the disclosed subject matter, they are by no means limiting and are exemplary embodiments. Many other embodiments will be apparent to those of skill in the art upon reviewing the above description. The scope of the subject matter described herein should, therefore, be determined with reference to the appended claims, along with the full scope of equivalents to which such claims are entitled.

This written description uses examples to disclose several embodiments of the subject matter set forth herein, including the best mode, and also to enable a person of ordinary skill in the art to practice the embodiments of disclosed subject matter, including making and using the devices or systems and performing the methods. The patentable scope of the subject matter described herein is defined by the claims, and may include other examples that occur to those of ordinary skill in the art. Such other examples are intended to be within the scope of the claims if they have structural elements that do not differ from the literal language of the claims, or if they include equivalent structural elements with insubstantial differences from the literal languages of the claims.

While only certain features of the invention have been illustrated and described herein, many modifications and changes will occur to those skilled in the art. It is, therefore, to be understood that the appended claims are intended to cover all such modifications and changes as fall within the true spirit of the invention.

What is claimed is:

1. A bipolar plate comprising:
a constricted flow field channel arrangement comprising one or more constricted flow channels attached to an inlet at a first end and an outlet at a second end,
wherein the constricted flow channels comprise a micro-channel and a primary channel.

2. The bipolar plate of claim 1, wherein the constricted flow field channel arrangement comprises more than one constricted flow channel in an alternating arrangement.

3. The bipolar plate of claim 1, wherein the micro-channel comprises a cross-sectional area greater than zero and smaller than a cross-sectional area of the primary channel.

4. The bipolar plate of claim 3, wherein a ratio of the cross-sectional area of the micro-channel to the cross-sectional area of the primary channel is about zero to about 1.

5. The bipolar plate of claim 3, wherein the cross-sectional area of the micro-channel is determined by the width or height of the micro-channel.

6. The bipolar plate of claim 1, wherein a length of the micro-channel is less than a length of the primary channel.

7. A modular bipolar plate comprising more than one flow field channel arrangement modules arranged between an inlet and an outlet, wherein a fluid is configured to flow through the flow field channel arrangement from the inlet to the outlet.

8. The modular bipolar plate of claim 7 comprising at least two modules.

9. The modular bipolar plate of claim 7 comprising more than one constricted flow channels.

10. The modular bipolar plate of claim 7, wherein each module is connected to the inlet and the outlet via a feed channel.

11. The modular bipolar plate of claim 9, wherein the more than one constricted flow channels comprise a micro-channel and a primary channel.

12. The modular bipolar plate of claim 11, wherein the constricted flow channels in each module are arranged in an alternating arrangement.

13. The modular bipolar plate of claim 10, wherein each module is oriented at an angle relative to the feed channels.

14. A bipolar plate comprising a varying width arrangement having one or more channels with periodically variable channel size, wherein each channel comprises a wide region and a narrow region.

15. The bipolar plate of claim 14, wherein the wide region of each channel comprises a first rib configured to split the wide region into two distinct channels according to a split ratio.

16. The bipolar plate of claim 15, wherein the split ratio is 1:2.

17. The bipolar plate of claim 15, wherein the wide region further comprises a second rib, wherein the first rib and the second rib are configured to split the wide channel into three channels.

18. The bipolar plate of claim 17, wherein the split ratio is 1:3.

19. The bipolar plate of claim 17, wherein the wide region is split into a first channel, a second channel, and a third channel, and wherein the first channel is positioned to be offset from the third channel.

20. The bipolar plate of claim 15, wherein the first rib comprises one or more islands.
